(19) United States
(12) Patent Application Publication
(10) Pub. No.: US 2013/0194908 A1
(43) Pub. Date: Aug. 1, 2013

(54) Method of Resource Allocation and Signaling for Aperiodic Channel Sounding

(71) Applicants: Shiwei Gao, Nepean (CA); Robert Mark Harrison, Grapevine, TX (US); Zhijun Cai, Euless, TX (US); Yongkang Jia, Ottawa (CA); Hua Xu, Ottawa (CA); Jack Anthony Smith, Valley View, TX (US); James Earl Womack, Bedford, TX (US)

(72) Inventors: Shiwei Gao, Nepean (CA); Robert Mark Harrison, Grapevine, TX (US); Zhijun Cai, Euless, TX (US); Yongkang Jia, Ottawa (CA); Hua Xu, Ottawa (CA); Jack Anthony Smith, Valley View, TX (US); James Earl Womack, Bedford, TX (US)

(73) Assignee: RESEARCH IN MOTION LIMITED, Waterloo, ON (CA)

(21) Appl. No.: 13/814,848

(22) PCT Filed: Aug. 13, 2010
(86) PCT No.: PCT/US10/45547

§ 371 Date: Apr. 8, 2013

(51) Int. Cl. H04W 72/04

(52) U.S. Cl. CPC H04W 72/0406
USPC 370/203; 370/329

(57) ABSTRACT

A method for resource allocation. The method includes signaling a set of SRS subframes in which an SRS can be transmitted, wherein a UE not capable of aperiodic SRS transmission can be instructed to transmit periodic SRS in any of the SRS subframes. The method further includes signaling which of the SRS subframes are to be used for periodic SRS transmissions and which are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

### CROSS REFERENCE

This application is a filing under 35 U.S.C. 371 of International Application No. PCT/US2010/045547 filed Aug. 13, 2010, entitled “Method of Resource Allocation and Signaling for Aperiodic Channel Sounding” (Atty. Docket No. 39306-WO-PCT-4214-29700) which is incorporated by reference herein as if reproduced in its entirety.

### BACKGROUND

As used herein, the terms “user equipment” and “UE” might in some cases refer to mobile devices such as mobile telephones, personal digital assistants, handheld or laptop computers, and similar devices that have telecommunications capabilities. Such a UE might consist of a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device” and “user node” might be used synonymously herein.

Also as used herein, “higher layer signaling” refers to control messages that originate in higher protocol layers than the physical layer and that control the operation of the physical layer. Such messages are typically carried on physical channels other than physical control channels. Higher layer signaling is sent relatively infrequently to a UE, perhaps a few messages per second or less. Higher layer signaling that allows physical layer parameters to be set or changed at these rates is referred to as being “semi-static”.

By contrast, “dynamic signaling” as used herein refers to signaling that is sent frequently to control the physical layer. Such signaling comprises relatively small numbers of information bits, and may be sent continuously to a UE. Dynamic signaling is often carried on physical control channels that are optimized for the small size and tight delay requirements found in dynamic signaling.

As contemplated herein, UEs may be addressed individually in a “UE-specific” manner or as a group of UEs served by a cell in a “cell-specific” manner. A “UE-specific” message is therefore a message that is transmitted to a UE and intended to be used only by that UE. A “cell-specific” message is therefore a message transmitted to the group of UEs served by a cell that is intended to be used by all UEs in the cell. While cell-specific signaling is most often broadcast to multiple UEs that receive it simultaneously, it can also be sent to the different UEs at different times. Similarly, a UE-specific physical layer resource is one that is allocated to that UE, whereas a cell-specific physical layer resource may be allocated to multiple UEs in a cell. Furthermore, a UE-specific information element or parameter is information that is to be used by that UE, whereas a cell-specific information element or parameter is information that is to be used by all UEs served by a cell.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an Evolved Universal Terrestrial Radio Access Network (E-UTRAN) node B (eNB), a wireless access point, or a similar component rather than a traditional base station. As used herein, the term “access node” will refer to any component of the wireless network, such as a traditional base station, a wireless access point, or an LTE eNB, that creates a geographical area of reception and transmission coverage allowing a UA or a relay node to access other components in a telecommunications system. An access node may comprise a plurality of hardware and software. LTE may be said to correspond to Third Generation Partnership Project (3GPP) Release 8 (Rel-8 or R8) and Release 9 (Rel-9 or R9) while LTE-A may be said to correspond to Release 10 (Rel-10 or R10) and possibly to releases beyond Release 10.

The uplink (UL) refers to the communication link from the UE to the access node, and the downlink (DL) refers to the communication link from the access node to the UE. A UL grant is a control message on a physical control channel provided by the access node to the UE allowing it to transmit data to the access node. A DL grant is a control message on a physical control channel provided by the access node to the UE indicating to the UE that the access node will transmit data to the UE.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates the location of the sounding reference signal (SRS) in an LTE subframe.

FIG. 2 illustrates an LTE Rel-8 sounding reference signal subframe configuration.

FIG. 3 illustrates an example of an LTE system with mixed Rel-8 UEs with a single transmission antenna and Rel-10 UEs with multiple transmission antennas, according to an embodiment of the disclosure.

FIG. 4 illustrates an LTE Rel-8 cell-specific SRS configuration information element (IE).

FIG. 5 illustrates a cell-specific periodic SRS configuration IE, according to an embodiment of the disclosure.

FIG. 6 illustrates a subframe-based SRS resource partition, according to an embodiment of the disclosure.

FIG. 7 illustrates the timing of a multi-shot aperiodic SRS transmission, according to an embodiment of the disclosure.

FIG. 8 illustrates a signaling example in supporting aperiodic SRS, according to an embodiment of the disclosure.

FIG. 9 illustrates a bit-map based periodic srs subframe configuration, according to an embodiment of the disclosure.

FIG. 10 illustrates a bit-map based aperiodic srs subframe configuration, according to an embodiment of the disclosure.

FIG. 11 illustrates a Rel-8 UE-specific SRS configuration IE.

FIG. 12 illustrates a UE-specific aperiodic SRS configuration IE, according to an embodiment of the disclosure.

FIG. 13 illustrates a UE-specific aperiodic SRS configuration IE for a shared periodic and aperiodic resource, according to an embodiment of the disclosure.

FIG. 14 illustrates frequency hopping support for aperiodic SRS, according to an embodiment of the disclosure.

FIG. 15 illustrates a UE-specific aperiodic SRS configuration example with five UEs, according to an embodiment of the disclosure.

FIG. 16a illustrates cell-specific SRS subframes, according to an embodiment of the disclosure.

FIG. 16b illustrates frequency domain locations for aperiodic SRS transmission, according to an embodiment of the disclosure.

FIG. 17 illustrates an example of dynamic aperiodic SRS resource signaling with four bits, according to an embodiment of the disclosure.

FIG. 18 illustrates another example of dynamic signaling of aperiodic SRS with four bits, according to an embodiment of the disclosure.

FIG. 19 illustrates a method for resource allocation, according to an embodiment of the disclosure.

FIG. 20 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Channel sounding is sometimes used in wireless communication systems to obtain uplink channel state information for assigning modulation and coding schemes, for frequency selective scheduling of uplink transmissions, and, in the case of multiple input/multiple output (MIMO) operation, for selecting a rank and an antenna precoding matrix. In this technique, a known sounding signal waveform is typically transmitted between a transmitter and a receiver, and the channel state information is estimated at the receiver based on the known sounding signal. In 3GPP LTE Rel-8, a sounding reference signal (SRS) is typically transmitted periodically from each connected UE to an access node to facilitate uplink timing correction, scheduling, and link adaptation.

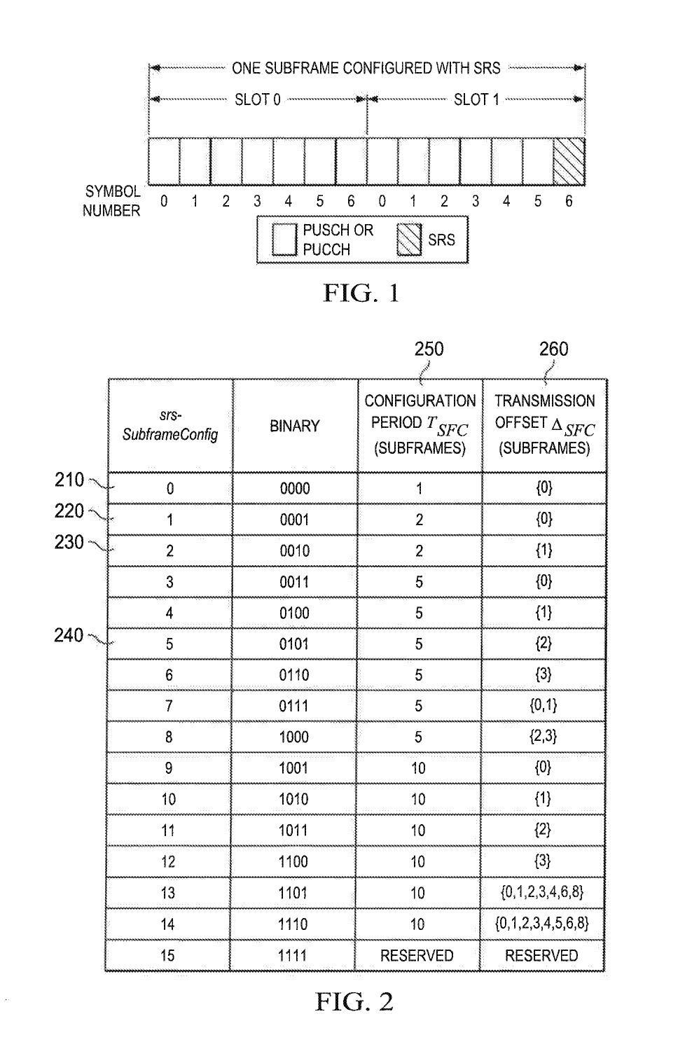

3GPP LTE defines system timing in terms of subframes and radio frames. Subframes are one millisecond long, whereas radio frames are 10 milliseconds long. Radio frames are numbered by system frame indices ranging from 0 to 1023. One or more subframes in a frame of ten subframes might be designated as subframes in which an SRS might be transmitted. In a subframe that has been configured for SRS transmission, the last symbol of the subframe is typically used for SRS transmission, as shown in FIG. 1.

In Rel-8, UE-specific SRS resources are defined in the frequency, time, and code domains in terms of UE-specific SRS bandwidth, frequency domain position, transmission comb, cyclic shift, subframe periodicity, and subframe offset. Cell-specific SRS resources are defined in both the frequency and time domains in terms of SRS periodicity, subframe offsets, and SRS bandwidth and are semi-statically configured in a cell. The cell-specific subframe configuration is shown in FIG. 2 and is indicated by “srs-SubframeConfig”. SRS subframes are the subframes satisfying └nₛ/2┘ mod T_{SFC}εΔ_{SFC}, where nₛ=0, 1, . . . , 19 is the slot index within a frame.

For example, for srs-SubframeConfig 0 in row 210 of FIG. 2, the configuration period in column 250 is 1 and the offset in column 260 is 0. The period of 1 means that every subframe in a frame of ten subframes is configured for SRS transmission. For srs-SubframeConfig 1 in row 220, the configuration period is 2 and the offset is 0. Therefore, every second subframe starting with subframe 0 is configured for SRS transmission in this case. For srs-SubframeConfig 2 in row 230, the configuration period is 2 and the offset is 1. Therefore, every second subframe starting with subframe 1 is configured for SRS transmission. As another example, srs-SubframeConfig 5 in row 240 has a configuration period of 5 and an offset of 2. Therefore, every fifth subframe starting with subframe 2 is configured for SRS transmission. It can be seen that for Rel-8, the SRS configurations are periodic, with a plurality of different periodicities being available.

In LTE Rel-10, it has been agreed that an aperiodic SRS will be supported in addition to the periodic SRS of Rel-8. That is, since a UE may not always have data to transmit in the uplink, in Rel-10 the SRS might be transmitted only when a UE has data to transmit. By use of such an aperiodic SRS transmission, fewer resources might be used and both SRS and system radio resource efficiency might be improved.

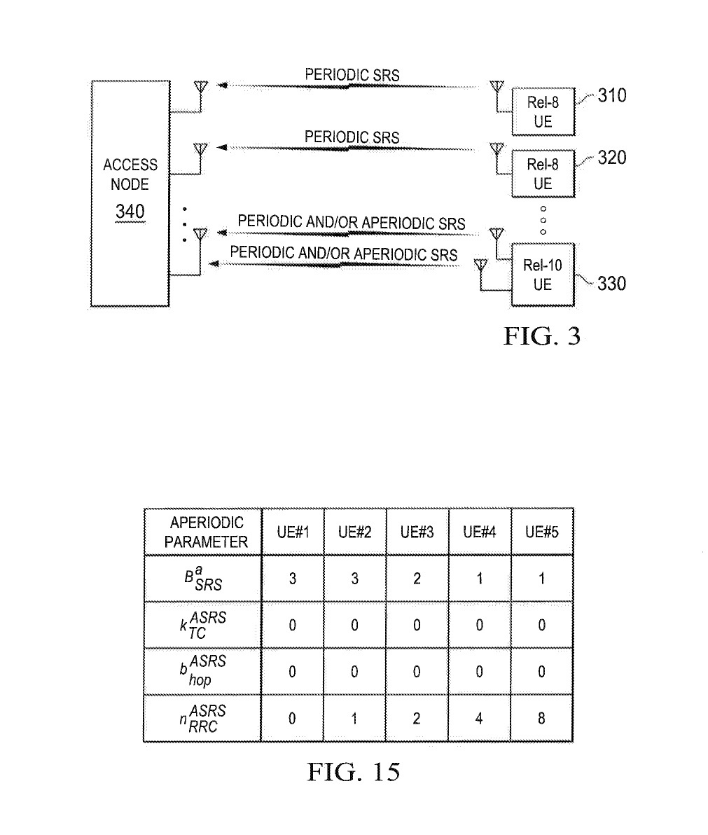

An example of such an LTE system is shown in FIG. 3, where a first UE 310 and a second UE 320 are Rel-8 UEs, each with a single transmit antenna, and a third UE 330 is a Rel-10 UE with two transmit antennas. In other embodiments, other numbers of Rel-8 and Rel-10 UEs could be present, and other numbers of antennas could be present on UE 330. UE 310 and UE 320 can transmit a periodic SRS to an access node 340. Each antenna on UE 330 can transmit a periodic SRS, an aperiodic SRS, or both to the access node 340.

While aperiodic SRS transmissions are allowed in Rel-10, details regarding the sharing of periodic and aperiodic resources are not defined. Embodiments of the present disclosure address issues related to aperiodic SRS transmissions such as cell-specific resource partitioning between periodic and aperiodic SRS, higher layer signaling of cell-specific aperiodic SRS resource allocation, higher layer signaling of UE-specific aperiodic SRS resource allocation, frequency hopping with narrow-band aperiodic SRS without dynamic signaling, and efficient dynamic signaling of UE-specific aperiodic SRS resource allocation. Some embodiments address these issues using a semi-static SRS configuration, and other embodiments address these issues using dynamic signaling of SRS resources. The semi-static solutions may have less signaling overhead than the dynamic solutions, but may not be as flexible. The dynamic solutions may offer more flexibility but may have a larger signaling overhead than the semi-static solutions.

In an embodiment, methods and systems of partitioning resources between periodic SRS and aperiodic SRS are provided. The Rel-8 cell-specific SRS subframe resources are divided into two parts, one for cell-specific periodic SRS and the other for cell-specific aperiodic SRS. The higher layer cell-specific SRS subframe configuration that is used in Rel-8 is used to inform UEs about the total SRS subframe resources. For both Rel-8 and Rel-10 UEs, this information is used by the UE to determine whether or not the last symbol of a subframe will be used for SRS transmission (either periodic or aperiodic) in order to avoid collisions between data and SRS transmissions. For Rel-10 UEs, in addition to the total cell-specific SRS resource allocation, the partition of the cell-specific SRS resources between periodic SRS transmission and aperiodic SRS transmission is also signaled through higher layers.

Such a technique of partitioning SRS subframes maintains the same overall SRS resource allocation capability as in Rel-8 in terms of percentage of subframes and subframe offsets configured for SRS. It allows flexible (but semi-static) partitioning of the total cell-specific SRS resources between periodic and aperiodic SRS. It also enables aperiodic SRS frequency hopping within the aperiodic partition without dynamically signaling the frequency domain resources.

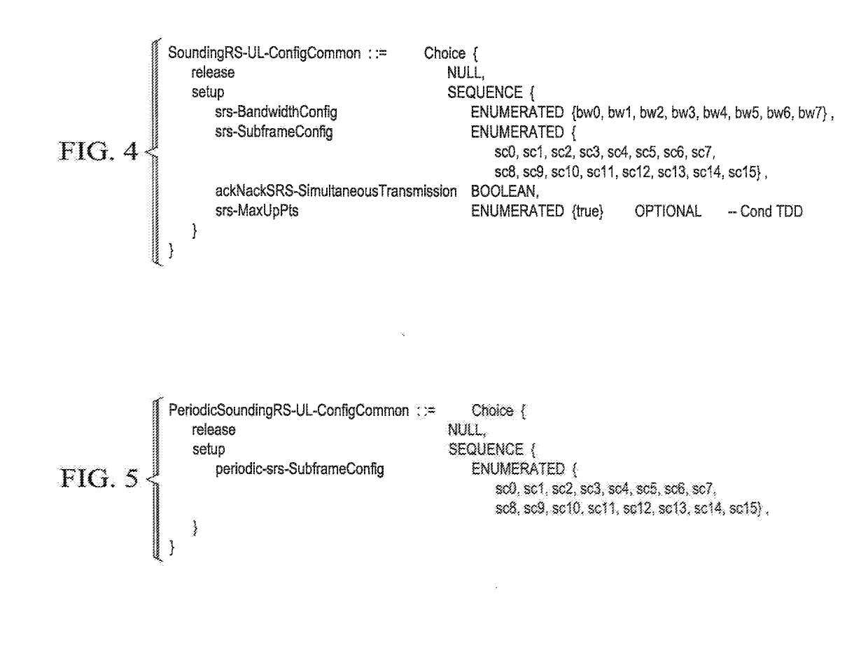

In this technique, the cell-specific SRS configuration of Rel-8 shown in FIG. 4 is used to configure the overall SRS subframes in a cell. The cell-specific SRS subframes are divided into two subsets, one for cell-specific periodic SRS and the other for cell-specific aperiodic SRS. This subframe partition is used only by Rel-10 UEs and is signaled using a new cell-specific periodic SRS configuration information element (IE) within the radio resource control (RRC) signaling as shown in FIG. 5, or alternatively a new cell-specific aperiodic SRS configuration IE is used. These IEs may be carried within the system information broadcast by the cell. The elements in FIGS. 4 and 5 will be described in more detail below.

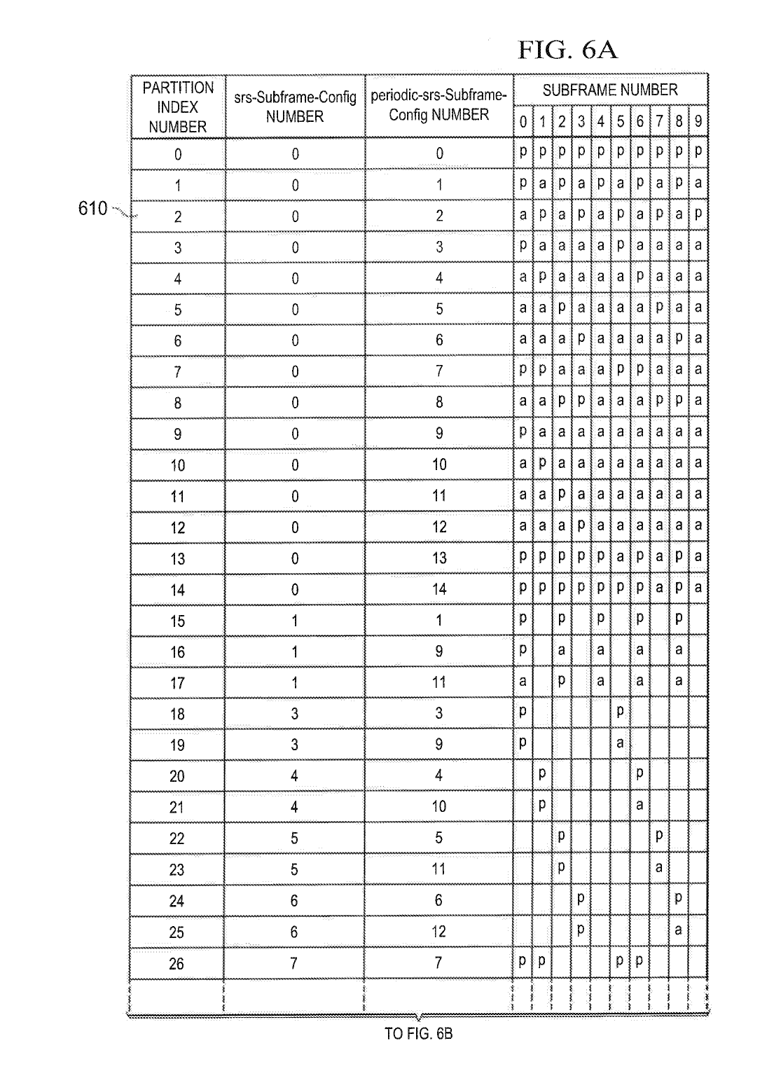

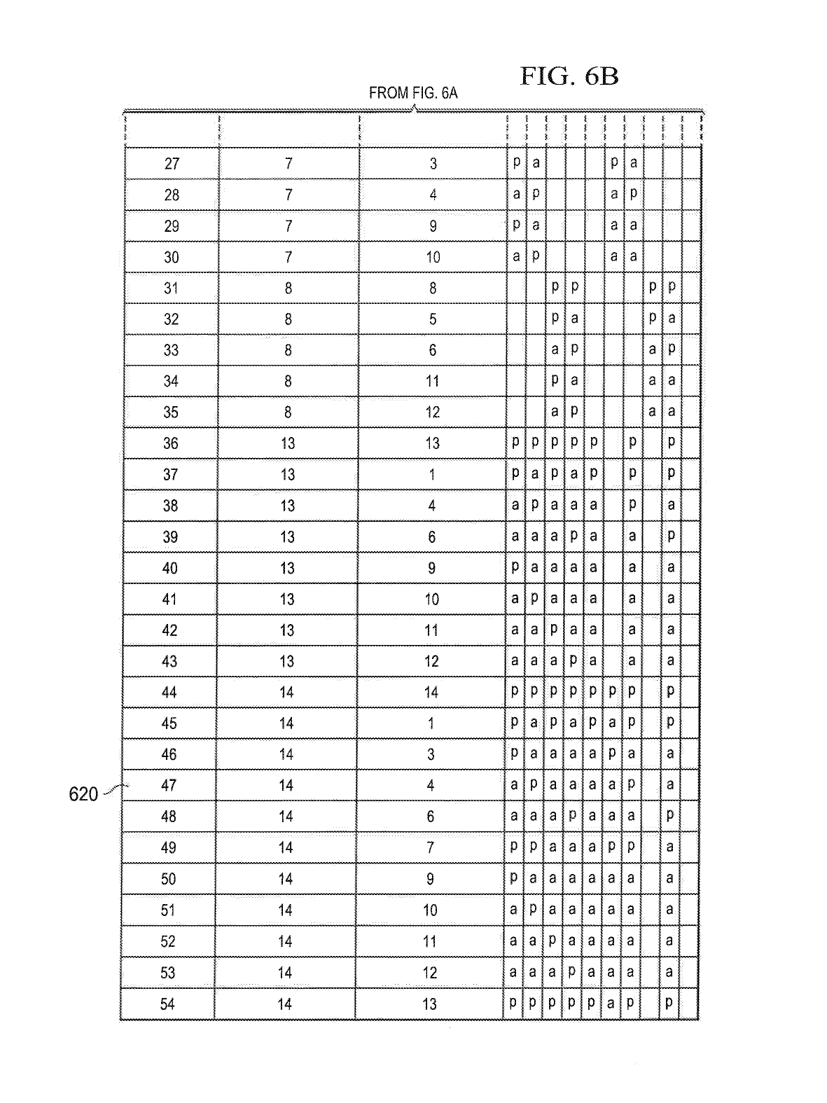

Some possible subframe partitions between periodic SRS and aperiodic SRS are shown in FIG. 6. For example, for partition #2 at row 610, srs-SubframeConfig #0 from FIG. 2 is broadcast to all the UEs served by the cell. That is, the periodicity is 1, meaning that all the subframes are configured for SRS transmission, as indicated by the presence of a letter in each subframe column in that row. UEs may transmit SRS in those subframes in the symbol allocated for SRS transmission. In addition, srs-SubframeConfig #2 from FIG. 2 is used only by Rel-10 UEs to determine the partition between periodic and aperiodic SRS subframes. That is, srs-SubframeConfig #2 has a periodicity of 2 and an offset of 1. Therefore, every other subframe starting with subframe 1 is designated for periodic SRS, as indicated by the letter “p” in those subframes. The remaining subframes are designated for aperiodic SRS, as indicated by the letter “a” in those subframes. In other words, in this example, 100% of the subframes are configured as cell-specific SRS subframes, half of which are configured for periodic SRS (subframes #1, 3, . . . ) and the other half for aperiodic SRS (subframes #0, 2, . . . ).

Using partition #47 at row 620 as another example, srs-SubframeConfig #14 is broadcast to all UEs. That is, as can be seen from FIG. 2, srs-SubframeConfig #14 has a periodicity of 10 and an offset of {0, 1, 2, 3, 4, 5, 6, 8}. Therefore, subframes 0, 1, 2, 3, 4, 5, 6, and 8 are configured for SRS transmission, as indicated by the presence of a letter in those subframe columns in that row. In addition, srs-SubframeConfig #4 is used only by Rel-10 UEs to determine the subframe partition. That is, as can be seen from FIG. 2, srs-SubframeConfig #4 has a periodicity of 5 and an offset of 1. Therefore, every fifth subframe starting with subframe 1 is designated for periodic SRS transmission, and the other subframes that are configured for SRS transmission are designated for aperiodic SRS transmission. In this case, 80% of the subframes are configured for SRS, with 20% configured for periodic SRS and 60% configured for aperiodic SRS.

It can be seen from FIG. 6 that such a partitioning method provides many possible combinations with different subframe usage ratios between periodic and aperiodic subframes, where srs-SubframeConfig # is used to inform all UEs about the total cell-specific SRS subframe configuration while periodic-srs-SubframeConfig # is used to inform Rel-10 UEs about the SRS subframes configured for periodic SRS. The table shown in FIG. 2 and used in Rel-8 for cell-specific SRS subframe configuration is used here. For example, srs-SubframeConfig #0 means all subframes are configured for SRS whereas periodic-srs-SubframeConfig #0 means all subframes are configured for periodic SRS. This approach allows the access node to partition the SRS subframes between periodic and aperiodic SRS flexibly based on different deployment scenarios while remaining backward compatible to Rel-8 UEs.

It should be noted that the table in FIG. 6 does not include an exhaustive list of all the possible combinations. Other combinations are also possible, such as (srs-SubframeConfig #, periodic-srs-SubframeConfig #)=(2, 10) or (2, 12).

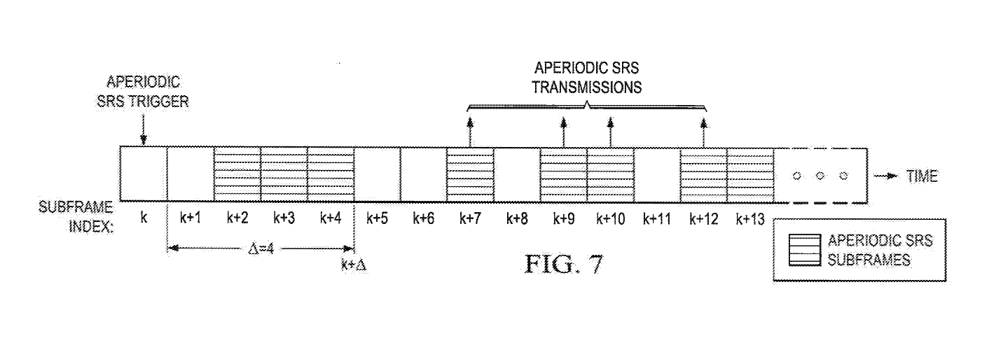

The actual aperiodic SRS transmission by a UE could be triggered using control signaling on a physical downlink control channel (PDCCH). Either an uplink grant or a downlink grant may be used on the PDCCH. As shown in FIG. 7, the actual timing of the transmission occurs at subframe n≧k+Δ, where k is the subframe at which the triggering is transmitted in downlink and Δ is a constant integer. Δ may be predefined, for example Δ=4. Δ is used because of processing delays. That is, when the UE receives the trigger in subframe k, it needs some time to formulate the transmission.

If the partition between periodic and aperiodic SRS is made on a subframe basis, then after receiving an SRS trigger in subframe k the UE checks if subframe k+Δ is configured for aperiodic SRS transmission (in cell-specific aperiodic SRS subframes). If subframe k+Δ is so configured, then the UE transmits an aperiodic SRS at that subframe. Otherwise, the aperiodic SRS transmission will occur at the first subframe that is configured for aperiodic SRS transmission after subframe k+Δ.

In the case where a multi-shot aperiodic SRS is triggered, the subsequent aperiodic SRS transmissions after the first transmission occur on the subsequent aperiodic SRS subframes immediately after the subframe used for the first transmission. This is shown in FIG. 7, where a burst of four SRS transmissions is assumed for the multi-shot aperiodic SRS. The aperiodic SRS trigger is carried in subframe k, and the first aperiodic SRS transmission is at subframe n=k+7, assuming Δ=4, because subframes k+5 and k+6 are not configured for aperiodic SRS. The subsequent three SRS transmissions occur at subframes k+9, k+10 and k+12 because subframes k+8 and k+11 are not configured for aperiodic SRS.

In an embodiment, the cell-specific SRS resource as defined in Rel-8 continues to be signaled to Rel-8 UEs. For Rel-10 UEs, in addition to such signaling, the partition of periodic and aperiodic SRS is signaled. Such partition information can be signaled by informing the Rel-10 UEs of either the periodic SRS subframes or the aperiodic SRS subframes. If periodic subframes are signaled, the remaining SRS subframes are assumed to be aperiodic. If aperiodic subframes are signaled, the remaining SRS subframes are assumed to be periodic. It may be preferable to inform the Rel-10 UEs of the periodic SRS subframes because the Rel-8 subframe configuration can be reused and no new SRS subframe definition is required.

Because Rel-8 signaling of the SRS subframe configuration is used to inform all UEs served by a cell about the total SRS subframe resources, Rel-8 UEs that are not capable of aperiodic SRS transmission can be instructed by the access node to transmit periodic SRS in any of the SRS subframes. This means that Rel-8 UEs could transmit in subframes that contain aperiodic SRS transmissions from Rel-10 UEs. The access node prevents this conflict by instructing Rel-8 UEs to transmit their periodic SRS transmissions in periodic subframes, rather than aperiodic subframes. This is accomplished by setting each Rel-8 UE's UE-specific periodicity, Tₛᵣₛ, and its UE-specific subframe offset, T_{offset}, such that each of its SRS transmissions is confined within periodic subframes. For example in FIG. 6, Rel-8 UEs configured for partition #2 at row 610 will have srs-SubframeConfig #0, and therefore can be configured to transmit in any SRS subframe. In order to avoid transmitting in an aperiodic subframe, the Rel-8 UEs should be configured to transmit their periodic SRS only in those subframes marked by a ‘p’ (subframes 1, 3, 5, 7, and 9). This can be done by setting Tₛᵣₛ to 5, and T_{offset} to 1, 3, or 5. Similarly, UEs configured for partition #47 at row 620 should be set to have a Tₛᵣₛ of 5 and T_{offset} of 4 to ensure that their transmissions are only in subframes 1 and 6. Note that each Rel-8 UE need not transmit periodic SRS in all subframes that contain periodic SRS in the cell.

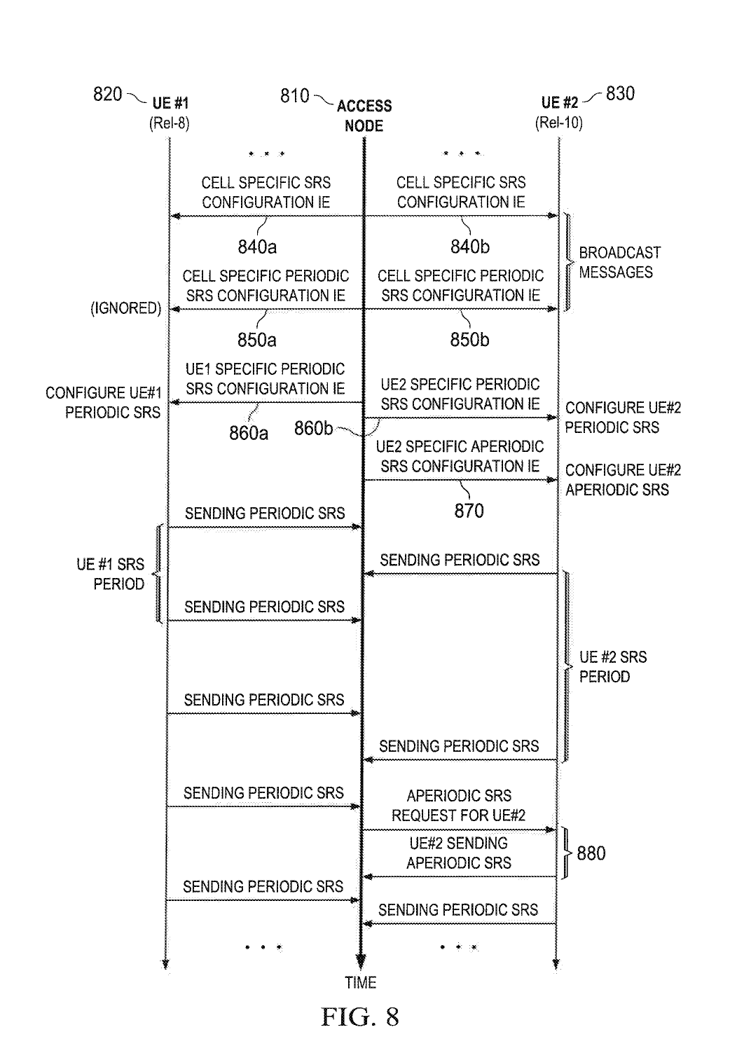

A signaling example with the above cell-specific SRS resource allocation is shown in FIG. 8. An access node 810 is in communication with at least one Rel-8 UE 820 and at least one Rel-10 UE 830. IEs 850 and 870 are the new IEs, while the remaining IEs are existing Rel-8 IEs. The “Cell specific periodic SRS configuration IE” 850 is broadcast by the access node 810 and received by UE 820 as 850a and by UE 830 as 850b. “Cell specific periodic SRS configuration IE” 850 is a new IE and thus will be ignored by Rel-8 UEs, such as UE 820. However, this IE 850 is used to inform Rel-10 UEs, such as UE 830, about the cell-specific SRS subframe partition between periodic SRS and aperiodic SRS as shown in FIG. 6. For Rel-10 UE 830, an additional UE-specific (or dedicated) aperiodic SRS IE 870 is transmitted to inform the UE 830 about its UE-specific aperiodic SRS configuration. All of these IEs are configured semi-statically through higher layer (e.g., layer-3, RRC) signaling. When the access node 810 needs UE 830 to perform dynamic uplink sounding, it sends an aperiodic SRS request 880 to the UE 830 through an uplink grant or a downlink grant. When UE 830 receives the request, it transmits an SRS according to both the cell-specific and the UE-specific aperiodic SRS configurations received previously.

The “Cell specific SRS configuration IE” 840 in FIG. 8 is known as the “SoundingRS-UL-ConfigCommon” IE in Rel-8 and is shown in detail in FIG. 4, where sc0 corresponds to Rel-8 cell-specific srs-SubframeConfig #0 as shown in FIG. 2, sc1 corresponds to srs-SubframeConfig #1 as shown in FIG. 2, and so on. bw0 corresponds to Rel-8 cell-specific SRS bandwidth configuration C_{SRS}=0, bw1 corresponds to bandwidth configuration C_{SRS}=1, and so on.

The “Cell specific periodic SRS configuration IE” 850 in FIG. 8 is a new IE and is shown in FIG. 5 as the “PeriodicSoundingRS-UL-ConfigCommon” IE, where the parameter “periodic-srs-SubframeConfig” defines the subframes that are configured for periodic SRS. When a Rel-10 UE receives this IE, it can determine the cell-specific periodic SRS subframes as well as the cell-specific aperiodic SRS subframes by subtracting the periodic subframes from the total cell-specific subframes. For example, when srs-SubframeConfig=0 and periodic-srs-SubframeConfig=1, Rel-10 UEs can determine from FIG. 6 that subframes {0, 2, 4, 6, 8} are cell-specific periodic SRS subframes and subframes {1, 3, 5, 7, 9} are cell-specific aperiodic subframes.

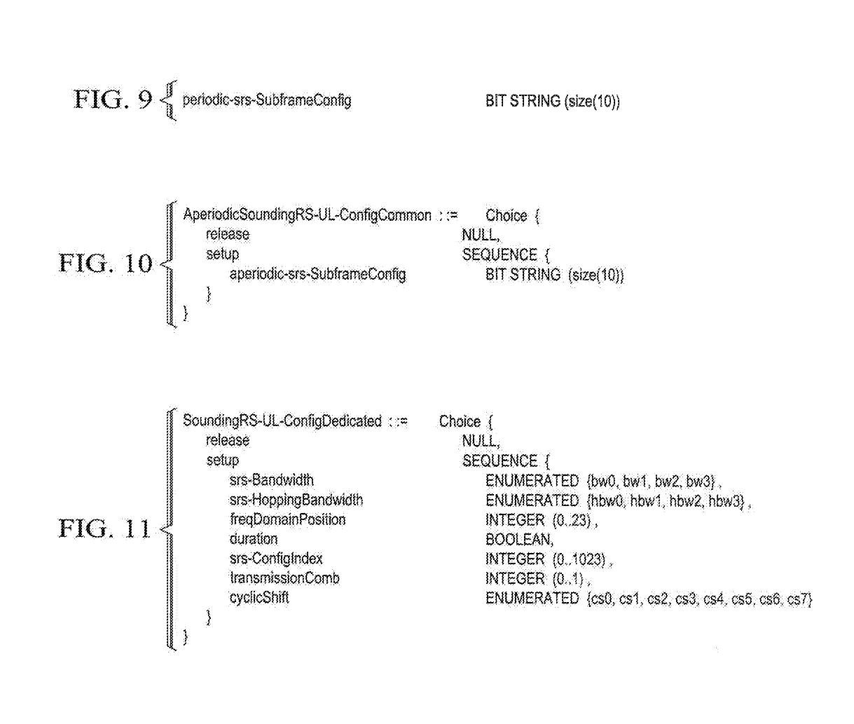

Alternatively, the “periodic-srs-SubframeConfig” parameter in FIG. 5 could be signaled by using a 10-bit bit map as shown in FIG. 9, where the most significant bit is associated with subframe #0. For example, partition #3 in FIG. 6 could be indicated as [1000010000] where subframes #0 and #5 are configured for periodic SRS.

In another embodiment, instead of signaling the cell-specific periodic SRS subframe configuration as in FIG. 8, a cell-specific aperiodic SRS subframe configuration could be signaled using a bit-mapped approach as shown FIG. 10, where the most significant bit is associated with subframe #0. For example, partition #3 in FIG. 6 could be indicated as [0111101111] where subframes {1, 2, 3, 4, 6, 7, 8, 9} are configured for aperiodic SRS.

In an embodiment, for UE-specific (or dedicated) aperiodic SRS configuration, a new IE is introduced in addition to the Rel-8 UE-specific IE. The existing IE in Rel-8 is shown in detail in FIG. 11 and corresponds to the “UE specific periodic SRS configuration IE” 860 in FIG. 8. The new additional IE is shown in detail in FIG. 12 and corresponds to the “UE specific aperiodic SRS configuration IE” 870 in FIG. 8. For both of the IEs, bw0 corresponds to Rel-8 UE-specific SRS bandwidth configuration B_{SRS}=0, bw1 corresponds to SRS bandwidth configuration B_{SRS}=1, and so on. hbw0 corresponds to Rel-8 UE-specific hopping bandwidth bₕₒₚ=0, hbw1 corresponds to hopping bandwidth bₕₒₚ=1, and so on. cs0 corresponds to cyclic shift index n_{SRS}^{CS}=0 defined in Rel-8, cs1 corresponds to cyclic shift index n_{SRS}^{CS}=1, and so on. The parameter “aperiodic-duration” in FIG. 12 defines the number of aperiodic SRS transmissions with a single aperiodic SRS request or trigger, where dur1 corresponds to a single transmission, dur2 corresponds to two transmissions, and so on. Alternatively, four durations could be predefined, where dur1 corresponds to the first predefined value, dur2 corresponds to the second predefined value, and so on.

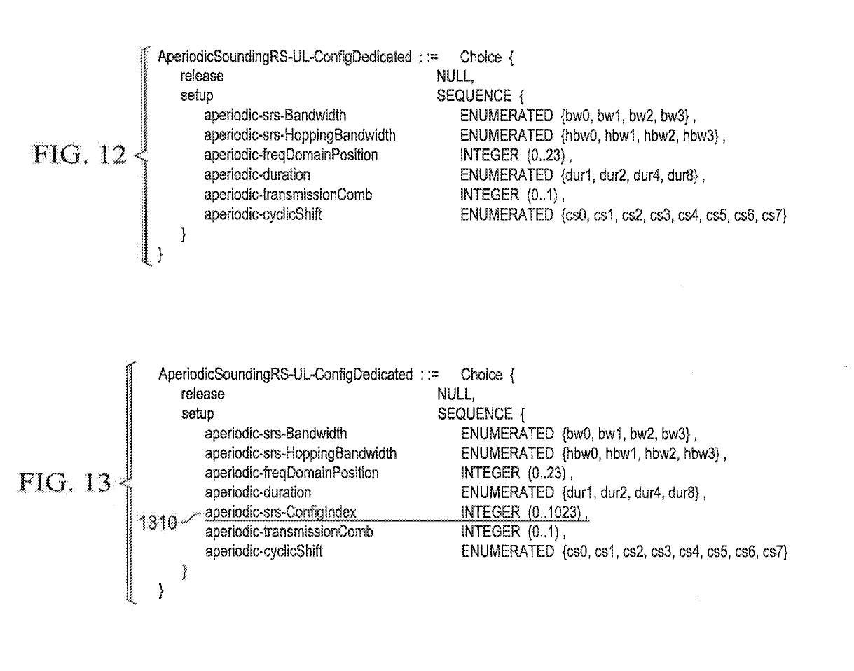

In the embodiment where aperiodic and periodic SRS share the same subframes, slightly different signaling is used. The PeriodicSoundingRS-UL-ConfigCommon IE is not used, and a modified AperiodicSoundingRS-UL-ConfigDedicated IE shown in FIG. 13 is used. The aperiodic-srs-ConfigIndex variable 1310 is added in order to indicate to the UEs the subframes in which they may transmit aperiodic SRS. The variable has the same definition as the srs-ConfigIndex in Rel-8 and indicates the UE-specific periodicity, Tₛᵣₛ, and the UE-specific subframe offset, T_{offset}, to be used for the UE's aperiodic SRS transmissions. By setting Tₛᵣₛ and T_{offset} for each UE, the access node may flexibly allocate SRS resource among periodic and aperiodic transmissions and among UEs. Because the AperiodicSoundingRS-UL-ConfigDedicated allows the resource blocks occupied by the UE, and/or its SRS comb, and/or its cyclic shift to be set, UEs may transmit both aperiodic and periodic SRS in the same subframe with little or no mutual interference when the periodic and aperiodic SRS transmissions are on different RBs, combs and/or cyclic shifts.

For Rel-10 UEs configured with multiple transmit antennas, it is assumed that all the UE-specific parameters in FIG. 11 and FIG. 12 are common to all the transmit antennas except “cyclicShift” and “aperiodic-cyclicShift”, which are for the first transmit antenna. For other antennas, an implicit rule can be used to derive the cyclic shift. For example, the cyclic shift for the ith transmit antenna may be derived as follows:

cyclicShift(i)=(cyclicShift+i*deltaCyclicShift)mod 8

aperiodic-cyclicShift(i)=(aperiodic-cyclicShift+i*deltaCyclicShift)mod 8

where i=0, 1, 2, 3 and deltaCyclicShift ranges from 1 to 7. deltaCyclicShift can be either predefined or configurable. When it is configurable, it can be part of either the cell-specific SRS configuration IE or the UE-specific SRS configuration IE.

In another embodiment, some of the UE-specific aperiodic SRS parameters in FIG. 12 or FIG. 13 may be the same as the corresponding UE-specific periodic SRS parameters in FIG. 11. In this case, only one set of parameters may be signaled. For example, “transmissionComb” for periodic SRS may be configured the same as “aperiodic-transmissionComb” and in this case, only “transmissionComb” is signaled.

In one embodiment, the duration of the aperiodic SRS or the number of aperiodic SRS transmissions after each trigger is semi-statically configured using the parameter “aperiodic-duration” as shown in FIG. 12. In another embodiment, the duration of the aperiodic SRS may be dynamically signaled to each UE through an uplink grant or a downlink grant over the PDCCH. Dynamic signaling results in more efficient usage of SRS resources but at the expense of additional signaling overhead.

In one embodiment, the aperiodic SRS transmission comb, frequency domain position, SRS bandwidth, cyclic shifts, and SRS hopping bandwidth may be semi-statically configured for each UE as shown in FIG. 12. The transmission comb could be configured such that one is for wideband SRS and the other for narrow-band SRS. Thus, based on whether a UE is at the cell edge or close to the access node, a transmission comb may be assigned semi-statically. This could be the same as that for periodic SRS, and thus a single parameter may be signaled.

SRS bandwidth may also be configured based on whether a UE is at the cell edge or close to the access node. Wideband sounding is generally good for UEs that are close to the access node and have power to sound the radio channel over a wider frequency band, while narrow-band sounding is good for UEs that are at the cell edge and have only enough power to sound the radio channel over a narrower frequency band. This configuration could be the same as that for periodic SRS, and thus a single parameter may be signaled. When a parameter is not defined in the UE-specific aperiodic SRS configuration IE in FIG. 12, the parameter in the UE-specific periodic SRS configuration IE in FIG. 11 can be assumed by a Rel-10 UE.

In another embodiment, some of these UE-specific aperiodic SRS parameters such as aperiodic-transmissionComb, aperiodic-freqDomainPosition, aperiodic-srs-bandwidth, aperiodic-srs-HoppingBandwidth and aperiodic-cyclicShift may be dynamically signaled together with an aperiodic SRS trigger. The semi-statically configured values may be overwritten when a dynamic configuration is received.

In an embodiment, for narrow-band SRS, multiple UEs can be multiplexed in the frequency domain and the frequency location for each of the UEs can vary from one subframe to another. That is, frequency hopping can be used. Frequency hopping can allow the benefits of narrow-band aperiodic SRS transmission, such as more transmit power available per subcarrier and more UEs multiplexed per SRS subframe, while allowing the radio channel to be sounded over the whole or a wider bandwidth. Dynamic signaling of the frequency domain locations is not needed, and thus less signaling overhead is required.

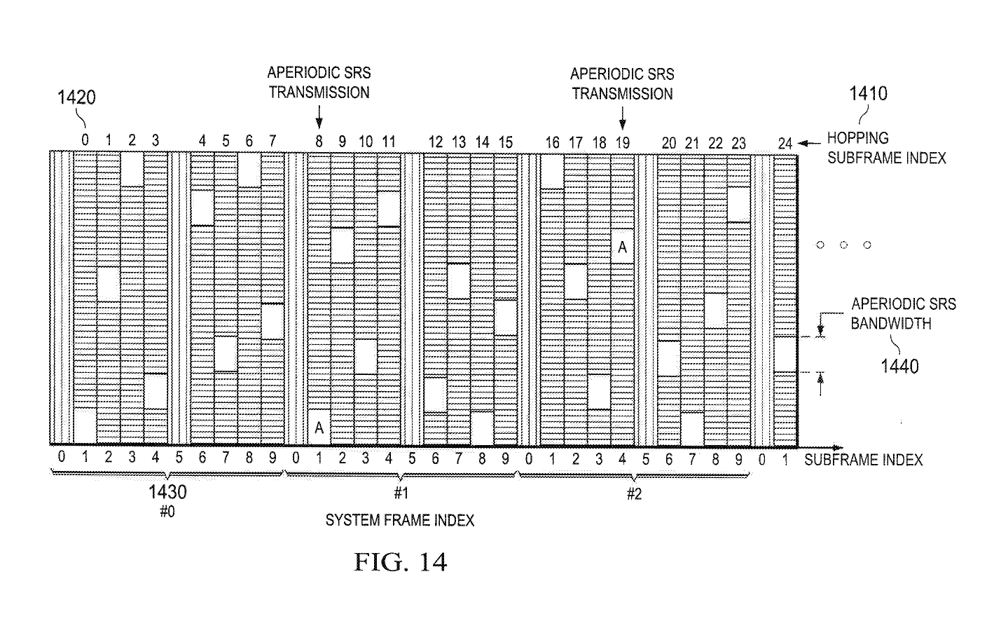

The frequency hopping patterns are assigned to the cell-specific aperiodic SRS subframes as shown by means of example in FIG. 14, in which a unique frequency hopping pattern is determined for a given aperiodic SRS configuration such as SRS bandwidth, SRS hopping bandwidth, etc. The vertically striped areas of FIG. 14 indicate periodic SRS subframes, the horizontally striped areas indicate aperiodic SRS subframes, and the white areas indicate possible aperiodic locations for a given UE-specific aperiodic SRS configuration.

The hopping subframe index 1410 starts at the first aperiodic subframe 1420 in system subframe #0 1430 and increments at each of the subsequent aperiodic SRS subframes (regardless of actual aperiodic SRS assignments). The frequency location varies as a function of the hopping subframe index 1410 according to a predetermined pattern that is known by all Rel-10 UEs and the access node. More specifically, the frequency location can be specified by equation 5 defined below. The hopping bandwidth 1440, which defines the bandwidth over which the sounding is performed, could be the same as periodic SRS, and in that case, a single parameter may be signaled.

Since a Rel-10 UE knows the cell-specific aperiodic SRS subframes and thus the hopping subframe index 1410 for a given aperiodic subframe, it is able to calculate the frequency domain location of its aperiodic SRS transmission if it is triggered or scheduled. An example is shown in FIG. 14, where aperiodic SRS are triggered at subframe 1 of system frame 1 and at subframe 4 of system frame 2, as indicated by the letter “A” in those locations. Since a UE knows the hopping pattern and the hopping subframe indices corresponding to the two subframes, it can easily determine the frequency locations for aperiodic SRS transmission on the two subframes.

For multi-shot aperiodic SRS in which multiple aperiodic SRS transmissions could be scheduled by a single trigger, a UE can also determine the subsequent subframes for SRS transmission based on the cell-specific aperiodic SRS resources (subframes within a frame) and may also determine the frequency locations in each of those subframes according to the hopping subframe index and the predetermined pattern.

This hopping scheme allows for uplink sounding over a wider bandwidth with narrow-band aperiodic SRS without dynamically signaling the frequency domain locations, and thus less signaling overhead is required. Details of this frequency hopping technique are now provided.

When an aperiodic SRS transmission for a UE is triggered at system frame n_{f} and slot nₛ and for a given system bandwidth, the starting frequency location or subcarrier index, k₀(n_{f},nₛ), can be calculated as follows:

$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where & ( 1 ) \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} & ( 2 ) \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ \begin{matrix}{F}_{b} ( {n}_{SRS} ) + \\ ⌊ 4 {n}_{RRC}^{ASRS} / {m}_{SRS , b} ⌋\end{matrix} \} mod {N}_{b} & otherwise\end{matrix} & ( 3 ) \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′}}} ⌋ + \\ ⌊ \frac{{n}_{SRS} mod {\prod }_{{b}^{′} = {b}_{hop}^{ASRS}}^{b} {N}_{{b}^{′ }}}{2 {\prod }_{{b}^{′} = {b}_{hop}^{ASRS}}^{b - 1} {N}_{{b}^{′}}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & ( 4 ) \\ where {N}_{{b}_{hop}^{ASRS}} = 1 and & \\ {n}_{SRS} = {n}_{f} {N}_{ASRS} + {\sum }_{n = 0}^{⌊ {n}_{s} / 2 ⌋} g ( n ) & ( 5 )\end{matrix}$$

where N_{ASRS} is the number of entries in T_{offset}^{ASRS}, i.e. the number of aperiodic SRS subframes in each frame, and

$$g ( n ) = \{ \begin{matrix}1 , & if n ∈ {T}_{offset}^{ASRS} \\ 0 , & otherwise\end{matrix} \qquad ( 6 )$$

where └x┘ indicates the maximum integer that is less than or equal to x. Other parameters are defined as follows:
N_{RB}^{UL} is the uplink system bandwidth in number of resource blocks (RBs);
N_{SC}^{RB} is the number of sub-carriers per RB;
C_{SRS} is the cell-specific SRS bandwidth configuration index defined by srs-BandwidthCon fig in the SoundingRS-UL-ConfigCommon IE shown in FIG. 4;
S_{SRS} is the cell-specific SRS subframe configuration index defined by srs-SubframeConfig in the SoundingRS-UL-ConfigCommon IE shown in FIG. 4;
S_{PSRS} is the cell-specific periodic SRS subframe configuration index defined by periodic-srs-SubframeConfig in the PeriodicSoundingRS-UL-ConfigCommon IE shown in FIG. 5; T_{offset}^{ASRS} is the cell-specific aperiodic SRS transmission subframe offsets, which can be derived from S_{SRS} and S_{PSRS}. For example, if S_{SRS}=0 and S_{PSRS}=1, then from FIG. 6, T_{offset}^{ASRS}={1, 3, 5, 7, 9};
B_{SRS}^{a} is the UE-specific aperiodic SRS bandwidth defined by aperiodic-srs-Bandwidth in the AperiodicSoundingRS-UL-ConfigDedicated IE shown in FIG. 12;
k_{TC}^{ASRS} is the UE-specific aperiodic SRS transmission comb defined by aperiodic-transmissionComb (0 or 1) in the AperiodicSoundingRS-UL-ConfigDedicated IE shown in FIG. 12;
bₕₒₚ^{ASRS} is the UE-specific aperiodic SRS hopping bandwidth defined by aperiodic-srs-HoppingBandwidth (0 to 3) in the AperiodicSoundingRS-UL-ConfigDedicated IE shown in FIG. 12;
n_{RRC}^{ASRS} is the UE-specific aperiodic SRS frequency domain position defined by aperiodic-freqDomainPosition (0 to 23) in the AperiodicSoundingRS-UL-ConfigDedicated IE shown in FIG. 12;
m_{SRS,b} is the aperiodic SRS bandwidth in number of RBs and can be obtained based on C_{SRS} and B_{SRS}^{a};
n_{b} is the SRS bandwidth configuration parameter and can also be obtained based on C_{SRS} and B_{SRS}^{a};
n_{f} is the system frame number (0 to 1023) in which the aperiodic SRS is to be transmitted;
nₛ is the slot number (0 to 19) in which the aperiodic SRS is to be transmitted.

It can be seen that the hopping pattern calculation is similar to the periodic SRS hopping in LTE Rel-8. The difference is that in Rel-8 periodic SRS, hopping occurs only on the subframes assigned to a UE. Since the SRS subframes are pre-configured for a UE, a UE can calculate its frequency location at each SRS transmission. In the dynamic aperiodic SRS case, a UE does not know the subframes for its future aperiodic SRS transmission; thus, it cannot pre-calculate its hopping pattern. In the disclosed hopping calculation, the hopping is defined at a cell level on the cell-specific aperiodic SRS subframes. The benefit of this approach is that the starting frequency position for aperiodic SRS does not need to be signaled dynamically to a UE at each trigger. A UE can determine its frequency domain starting position for aperiodic SRS transmission based on the semi-statically configured aperiodic SRS parameters and the subframe in which the aperiodic SRS is triggered to be transmitted.

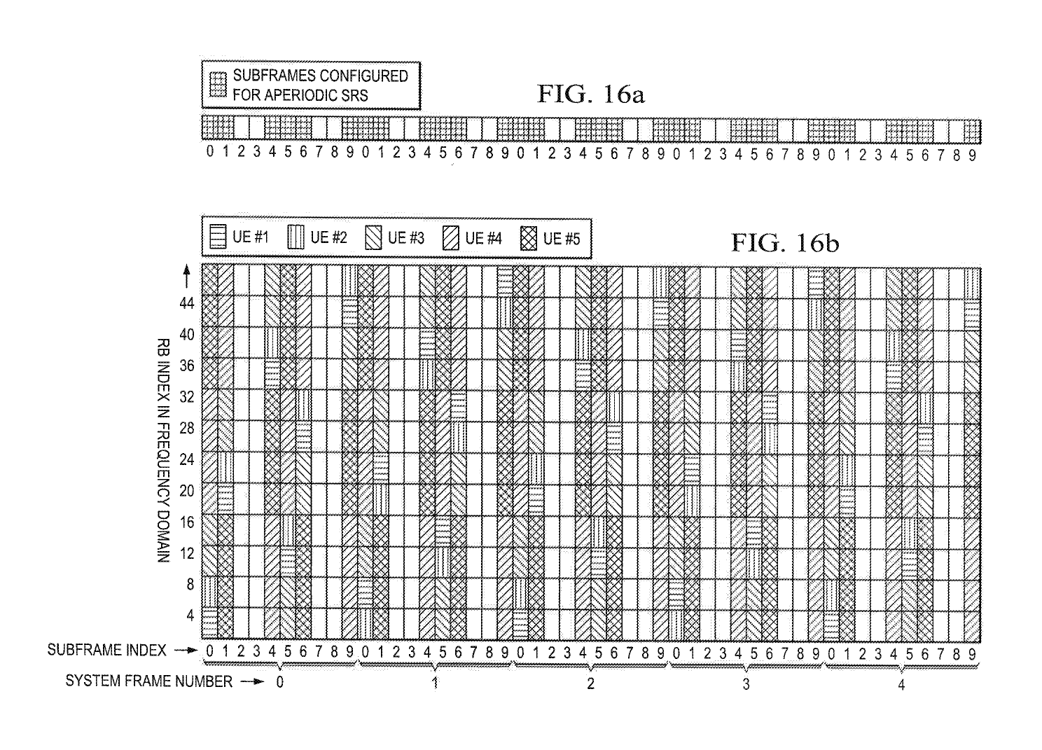

For example, considering five UEs with the UE-specific aperiodic SRS configurations shown in FIG. 15 and cell-specific aperiodic SRS subframe configuration shown in 16a and cell-specific SRS bandwidth configurations {C_{SRS}=1, S_{SRS}=0, S_{PSRS}=8 and N_{RB}^{UL}=50}, the possible aperiodic SRS starting locations in frequency for the five UEs can be calculated using the above-mentioned formulas from (1) to (6), and the results over the first 50 subframes are shown in FIG. 16b. FIG. 16b shows the RBs that would be occupied by the SRS transmission of each of the five UEs if it were to be triggered in each of the subframes. A UE's occupied RBs start at its starting frequency location and occupy the number of RBs set by its UE-specific aperiodic SRS configuration. Thus, for a given aperiodic SRS configuration, the starting frequency location can be calculated for any subframe configured for aperiodic SRS. Hence, when an aperiodic SRS is triggered, a UE can easily figure out the starting frequency location at which the aperiodic SRS should be transmitted. No dynamic signaling is required to inform a UE of the frequency location at each trigger. Furthermore, multi-shot aperiodic SRS can also be easily supported without dynamic signaling of the frequency locations.

In the embodiment with shared periodic and aperiodic SRS resources, it may be necessary to modify equation (5), since there are no aperiodic-only subframes in this case. In this case, the Release 8 definition of n_{SRS} is modified as follows:

n_{SRS}=└(n_{f}×10+└nₛ/2┘)/T_{ASRS}┘ (5a)

where T_{ASRS} is for the aperiodic SRS transmissions and is defined by the parameter aperiodic-srs-ConfigIndex in the AperiodicSoundingRS-UL-ConfigDedicated IE, defined in FIG. 13. In another embodiment, T_{ASRS} may be configured as the same value for all Rel-10 UEs and thus may be broadcasted. In yet another embodiment, the value of T_{ASRS} may be predefined and known by both the access node and the Rel-10 UEs.

The above discussion has focused on semi-static SRS configuration. The discussion now turns to dynamic signaling for narrow-band aperiodic SRS. While partitioning periodic and aperiodic resources by subframe reduces the UE-specific signaling overhead and allows simple configuration of SRS resources, partitioning by subframe can lead to less efficient sharing of the available SRS resources. Therefore in an alternative embodiment, the SRS subframes are not partitioned between periodic SRS and aperiodic SRS resources via cell-specific signaling. Instead, each UE is independently informed about the SRS resources on which its aperiodic transmissions (as well as its periodic transmissions, if any) may take place. Since there is no fixed partition between SRS subframes in this embodiment, the access node must allocate the periodic and aperiodic resources such that inter-UE interference on SRS does not occur. Therefore, the access node still partitions the resource in the sense that UEs in a cell will generally not transmit on the same SRS resource (comb, cyclic shift, resource elements, and subframe). However, the SRS resource is controlled on a per-UE basis, and UEs are not informed of an aperiodic SRS resource shared by all UEs in the cell.

To fully exploit the benefit of dynamically sharing cell-specific SRS resources between periodic and aperiodic SRS for each UE and SRS transmissions among different UEs, the aperiodic SRS resource may be dynamically signaled to a UE without semi-statically partitioning the cell-specific SRS resources. This approach provides increased flexibility in resource allocation and sharing between periodic and aperiodic SRS and also among different UEs with moderate signaling overhead.

This more flexible approach allows for the SRS resources of each UE to be dynamically multiplexed together with different frequency locations, cyclic shifts, and transmission comb indices. This could improve SRS resource usage efficiency but might require dynamically signaling a combination of frequency location, cyclic shift, and comb index. A straightforward way to achieve this is to use a fixed number of bits to indicate orthogonal SRS resources efficiently. For example for 20 MHz bandwidth, the maximum number of combinations of frequency location, cyclic shift, and comb index for each antenna of a UE is at most 24×8×2=384 possibilities, which would require nine bits to signal. The benefits from a multiplexing gain perspective are likely to reduce as the number of bits increases. Hence, a balance needs to be struck between multiplexing gain and signaling overhead. As such, an alternative solution is to signal only a subset of these possibilities to each UE.

In one embodiment, n_{RRC}^{ASRS} is dynamically signaled with each aperiodic SRS trigger carried over the PDCCH. The number of bits for signaling n_{RRC}^{ASRS} is system bandwidth dependent. For a 20 MHz system bandwidth, there are a maximum of 24 possible starting frequency locations (24=96 RBs/4 RBs), and thus five bits are required. In the case of a 10 MHz system bandwidth, there are a maximum of 12 possible starting frequency locations (12=48 RBs/4 RBs), and thus four bits are required. For system bandwidths of 5 MHz and less, three bits are sufficient. The starting subcarrier index for aperiodic SRS transmission in this case can be calculated as follows:

$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where & ( 7 ) \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} & ( 8 ) \\ {n}_{b} = ⌊ 4 {n}_{RRC}^{ASRS} / {m}_{SRS , b} ⌋ mod {N}_{b} & ( 9 )\end{matrix}$$

In another embodiment, rather than signaling n_{RRC}^{ASRS} dynamically, an offset n may be signaled instead, where n_{RRC}^{ASRS}+n_{Δ} defines a frequency location that is shifted from the one indicated by n_{RRc}^{ASRS}, which is semi-statically signalled. The range of n_{Δ} can be smaller than n_{RRC}^{ASRS}, and thus less signaling overhead is required. Using a 10 MHz system bandwidth as an example, the range of n_{RRC}^{ASRS} is from 0 to 11. A subset of the range, for example {0, 2, 4, 8}, may be used for n_{Δ}, which needs only two bits to signal. The configuration of n_{Δ} can allow the sounding over a wide bandwidth to take advantage of frequency-selective scheduling. For that purpose, the range of n_{Δ} could be different for each system bandwidth. The previous equation (9) in this case may thus need to be modified as:

n_{b}=└4(n_{RRC}^{ASRS}+n_{Δ})/m_{SRS,b}┘ mod N_{b} (10)

In another embodiment, aperiodic-cyclicShift may also be dynamically signaled. This allows more flexibility in allocating and sharing SRS resources but with additional signaling overhead. Since there is a maximum of eight cyclic shifts available, three bits of overhead are required for signaling aperiodic-cyclicShift. In this case, up to eight bits of total signaling overhead are needed.

In another embodiment, rather than signaling aperiodic-cyclicShift dynamically, an offset aperiodic-cyclicShift-offset may be signaled instead, where the actual cyclic shift used for an aperiodic SRS transmission is given by a higher layer signaled parameter aperiodic-cyclicShift plus the dynamically signaled aperiodic-cyclicShift-offset. That is:

Aperiodic SRS cyclicShift=(aperiodic-cyclicShift+aperiodic-cyclicShift-offset)Mod 8 (11)

A smaller range could be defined for aperiodic-cyclicShift-offset, such as {0 1 2 4}, which requires less signaling overhead.

In the most general solution, higher layer signaling may indicate to the UE a list of SRS resources that the UE may transmit upon, where the list is small enough such that the elements of the list are addressable by a small number of bits (for example, no more than 4). Each element of the list indicates a combination of frequency location, cyclic shift, and comb index for each antenna that the UE may transmit upon. It should be noted that the lists are independently signaled to each UE, and the UEs' lists may be different. Subsequently, physical layer signaling over the PDCCH may be used to dynamically indicate to the UE the actual SRS resource to use for a particular aperiodic sounding.

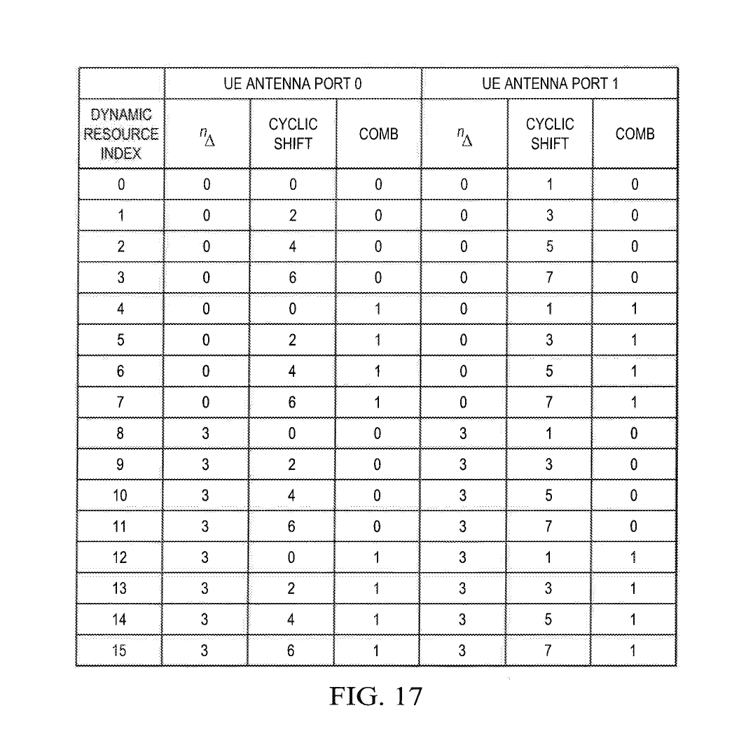

For example, a 10 MHz system can be considered, where the SRS bandwidth is relatively large (12 RBs for example) and thus, because the number of UEs that can be multiplexed in frequency is small, it is more important to multiplex among cyclic shifts and combs. In this case, the list of combinations in FIG. 17 might be signaled to one of the UEs (when four bits are used to dynamically indicate the SRS resource).

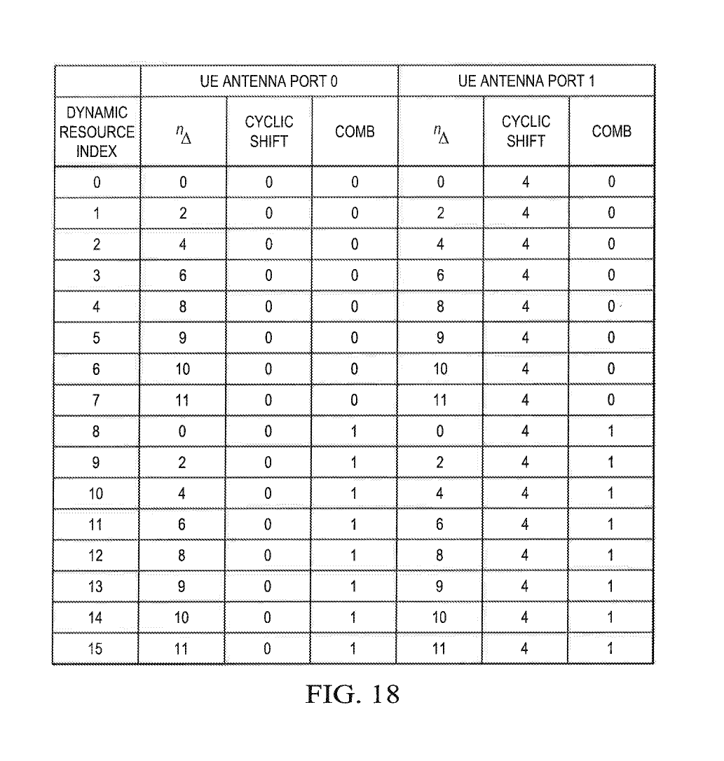

As another example, a 10 MHz system can again be considered, but where the SRS bandwidth is relatively narrow (4 RBs for example), and where, because more multiplexing in frequency is possible, it is less important to multiplex among cyclic shifts and/or combs. Because the orthogonality of cyclic shifts is reduced in a multipath channel with large delay spread, it may be desirable to assign cyclic shifts with a large separation to the antennas. In this case, the list of combinations in FIG. 18 might be signaled to one of the UEs.

Although only two antennas are shown in FIG. 17 and FIG. 18, this approach can be easily extended to UEs with more than two transmit antennas. In general, for a UE with N_{A} antennas, each row of FIG. 17 and FIG. 18 indicates N_{A} combinations of the 384 combinations of frequency location offset, cyclic shift, and comb, one for each of the N_{A} antenna ports. It is possible that one or more of the frequency offset, cyclic shift index, and comb index are fixed. In this case, those fixed parameters may be separately signaled from the lists.

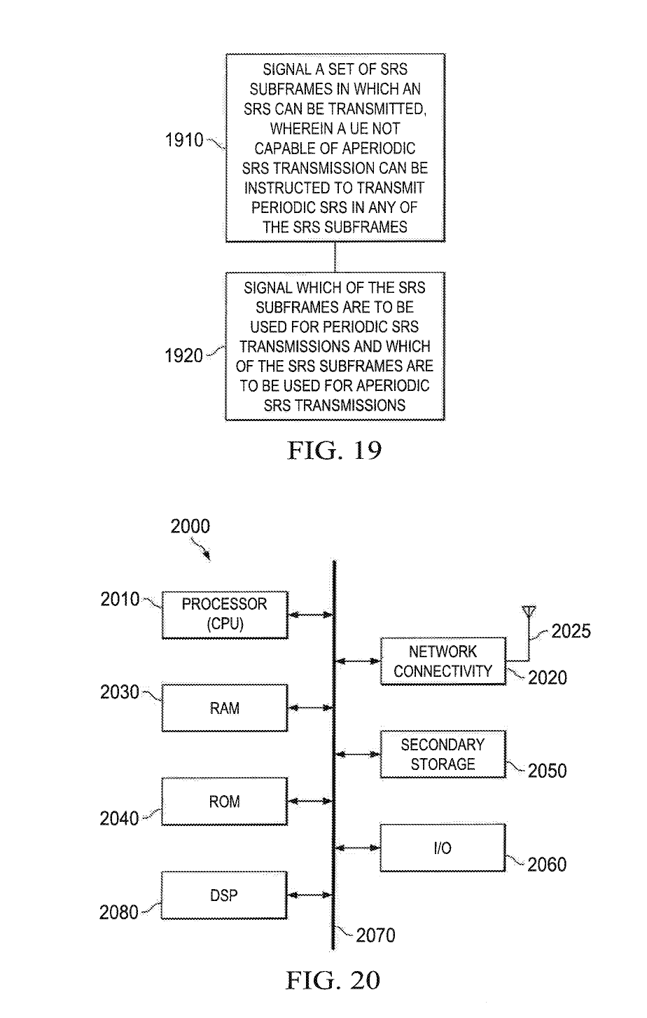

FIG. 19 illustrates an embodiment of a method for resource allocation. At block 1910, a set of SRS subframes is signaled in which an SRS can be transmitted. A UE not capable of aperiodic SRS transmission can be instructed to transmit periodic SRS in any of the SRS subframes. At block 1920, which of the SRS subframes are to be used for periodic SRS transmissions and which of the SRS subframes are to be used for aperiodic SRS transmissions is signaled. A periodic SRS transmission is an SRS transmission that is transmitted by a UE in a first subframe, the first subframe being determined at least by the subframe in which the UE transmitted a previous SRS and an SRS periodicity. An aperiodic SRS transmission is an SRS transmission that is transmitted by a UE in a second subframe, the second subframe being determined at least by a transmission on a physical control channel to the UE.

The access node, UE, and other components described above might include a processing component that is capable of executing instructions related to the actions described above. FIG. 20 illustrates an example of a system 2000 that includes a processing component 2010 suitable for implementing one or more embodiments disclosed herein. In addition to the processor 2010 (which may be referred to as a central processor unit or CPU), the system 2000 might include network connectivity devices 2020, random access memory (RAM) 2030, read only memory (ROM) 2040, secondary storage 2050, and input/output (I/O) devices 2060. These components might communicate with one another via a bus 2070. In some cases, some of these components may not be present or may be combined in various combinations with one another or with other components not shown. These components might be located in a single physical entity or in more than one physical entity. Any actions described herein as being taken by the processor 2010 might be taken by the processor 2010 alone or by the processor 2010 in conjunction with one or more components shown or not shown in the drawing, such as a digital signal processor (DSP) 2080. Although the DSP 2080 is shown as a separate component, the DSP 2080 might be incorporated into the processor 2010.

The processor 2010 executes instructions, codes, computer programs, or scripts that it might access from the network connectivity devices 2020, RAM 2030, ROM 2040, or secondary storage 2050 (which might include various disk-based systems such as hard disk, floppy disk, or optical disk). While only one CPU 2010 is shown, multiple processors may be present. Thus, while instructions may be discussed as being executed by a processor, the instructions may be executed simultaneously, serially, or otherwise by one or multiple processors. The processor 2010 may be implemented as one or more CPU chips.

The network connectivity devices 2020 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 2020 may enable the processor 2010 to communicate with the Internet or one or more telecommunications networks or other networks from which the processor 2010 might receive information or to which the processor 2010 might output information. The network connectivity devices 2020 might also include one or more transceiver components 2025 capable of transmitting and/or receiving data wirelessly.

The RAM 2030 might be used to store volatile data and perhaps to store instructions that are executed by the processor 2010. The ROM 2040 is a non-volatile memory device that typically has a smaller memory capacity than the memory capacity of the secondary storage 2050. ROM 2040 might be used to store instructions and perhaps data that are read during execution of the instructions. Access to both RAM 2030 and ROM 2040 is typically faster than to secondary storage 2050. The secondary storage 2050 is typically comprised of one or more disk drives or tape drives and might be used for non-volatile storage of data or as an over-flow data storage device if RAM 2030 is not large enough to hold all working data. Secondary storage 2050 may be used to store programs that are loaded into RAM 2030 when such programs are selected for execution.

The I/O devices 2060 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 2025 might be considered to be a component of the I/O devices 2060 instead of or in addition to being a component of the network connectivity devices 2020.

In an embodiment, a method for resource allocation is provided. The method includes signaling a set of SRS subframes in which an SRS can be transmitted, wherein a UE not capable of aperiodic SRS transmission can be instructed to transmit periodic SRS in any of the SRS subframes. The method further includes signaling which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

In another embodiment, an access node in a wireless telecommunications system is provided. The access node includes a processor configured such that the access node signals a set of SRS subframes in which an SRS can be transmitted, wherein a UE not capable of aperiodic SRS transmission can be instructed to transmit periodic SRS in any of the SRS subframes; and further configured such that the access node signals which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

In another embodiment, a UE is provided. The UE includes a processor configured such that the UE transmits an SRS, the UE having received a signal of a set of SRS subframes in which an SRS can be transmitted, wherein when the UE is a UE not capable of aperiodic SRS transmission the UE can be instructed to transmit periodic SRS in any of the SRS subframes, and the UE further having received a signal of which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

In another embodiment, a method for resource allocation is provided. The method includes dynamically signaling resources for a UE to use when transmitting an aperiodic SRS, wherein higher layer signaling indicates a set of resources that the UE can transmit on, and wherein dynamic physical layer signaling indicates which resources within the set of resources the UE is to use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

In another embodiment, an access node in a wireless telecommunications system is provided. The access node includes a processor configured such that the access node dynamically signals resources for a UE to use when transmitting an aperiodic SRS, wherein higher layer signaling indicates a set of resources that the UE can transmit on, and wherein dynamic physical layer signaling indicates which resources within the set of resources the UE is to use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

In another embodiment, a UE is provided. The UE includes a processor configured such that the UE transmits an aperiodic SRS on resources that were dynamically signaled to the UE for use in transmitting the SRS, wherein the dynamic specification of the resources comprised higher layer signaling that indicated a set of resources that the UE can transmit on and dynamic physical layer signaling that indicated which resources within the set of resources the UE can use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for resource allocation, comprising:
signaling a set of sounding reference signal (SRS) subframes in which an SRS can be transmitted, wherein a user equipment (UE) not capable of aperiodic SRS transmission can be instructed to transmit periodic SRS in any of the SRS subframes; and
signaling which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

2. The method of claim 1, wherein the set of SRS subframes in which the SRS can be transmitted is specified by a first entry in a table, each entry in the table containing a periodicity of allocated subframes and an offset from the first subframe at which the allocation period begins, and wherein the subframes to be used for periodic SRS transmissions and the subframes to be used for aperiodic SRS transmissions are specified by a second entry in the table, the periodicity portion of the second entry specifying a pattern of periodic and aperiodic subframes among the allocated subframes, and the offset portion of the second entry specifying an offset from the first subframe at which the pattern begins.

3. The method of claim 1, wherein the step of signaling which of the SRS subframes are to be used for periodic SRS transmissions and which of the SRS subframes are to be used for aperiodic SRS transmissions further comprises:
transmitting a first message to a first UE that indicates a first set of subframes in which the first UE may transmit aperiodic SRS; and
transmitting a second message to a second UE that indicates a second set of subframes in which the second UE may transmit periodic SRS, wherein in a subframe the first UE transmits aperiodic SRS on a first SRS resource and the second UE transmits periodic SRS on a second SRS resource, and wherein the first SRS resource and the second SRS resource are different, and wherein an SRS resource comprises at least one of an SRS cyclic shift or an SRS comb or a set of resource blocks.

4. The method of claim 1, wherein an access node transmits a cell-specific message that indicates which of the allocated subframes are one of periodic SRS subframes and aperiodic SRS subframes, and wherein the remainder of the allocated subframes are the other of periodic SRS subframes and aperiodic SRS subframes, and wherein only an aperiodic SRS is transmitted in aperiodic SRS subframe when an SRS is transmitted in the aperiodic SRS subframe.

5. The method of claim 4, wherein the access node further transmits a UE-specific message that contains UE-specific aperiodic SRS configuration information.

6. The method of claim 5, wherein the cell-specific message and the UE-specific message are semi-static higher layer signaling.

7. The method of claim 1, wherein the number of aperiodic SRS transmissions transmitted after a trigger is received is specified by one of a semi-static configuration and dynamic signaling.

8. The method of claim 1, wherein multiple aperiodic SRS signals are multiplexed in the frequency domain, and the frequency locations for each SRS signal vary in different subframes.

9. The method of claim 8, wherein the starting subcarrier index at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ 4 {n}_{RRC}^{ASRS} / {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′}}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′ }}} ⌋\end{matrix} & if {N}_{b} even \\ ⌊ {N}_{b} / 2 ⌋ ⌊ {n}_{SRS} / {{\prod }_{{b}^{′} = {b}_{hop}^{ASRS}}}^{b - 1} {N}_{{b}^{′ }} ⌋ & if {N}_{b} odd\end{matrix} & \\ where {N}_{{b}_{hop}^{ASRS}} = 1. & \end{matrix}$$

10. The method of claim 9, wherein n_{SRS} is calculated according to the equation
$${n}_{SRS} = {n}_{f} {N}_{ASRS} + {\sum }_{n = 0}^{⌊ {n}_{s} / 2 ⌋} g ( n )$$
where N_{ASRS} is the number of entries in T_{offset}^{ASRS}, i.e. the number of aperiodic SRS subframes in each frame, and
$$g ( n ) = \{ \begin{matrix}1 , & if n ∈ {T}_{offset}^{ASRS} \\ 0 , & otherwise\end{matrix}$$
where └x┘ indicates the maximum integer that is less than or equal to x.

11. The method of claim 3, wherein multiple aperiodic SRS signals are multiplexed in the frequency domain, and the frequency locations for each SRS signal vary in different subframes, and wherein the starting subcarrier index at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ 4 {n}_{RRC}^{ASRS} / {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′ }}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′ }}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & \end{matrix}$$
where N_{b}_{ₕₒₚ}_{^{ASRS}}=1, and wherein n_{SRS} is calculated according to the equation
n_{SRS}=└(n_{f}×10+└nₛ/2┘)/T_{ASRS}┘.

12. An access node in a wireless telecommunications system, comprising:
a processor configured such that the access node signals a set of sounding reference signal (SRS) subframes in which an SRS can be transmitted, wherein a user equipment (UE) not capable of aperiodic SRS transmission can be instructed to transmit periodic SRS in any of the SRS subframes; and further configured such that the access node signals which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

13. The access node of claim 12, wherein the set of SRS subframes in which the SRS can be transmitted is specified by a first entry in a table, each entry in the table containing a periodicity of allocated subframes and an offset from the first subframe at which the allocation period begins, and wherein the subframes to be used for periodic SRS transmissions and the subframes to be used for aperiodic SRS transmissions are specified by a second entry in the table, the periodicity portion of the second entry specifying a pattern of periodic and aperiodic subframes among the allocated subframes, and the offset portion of the second entry specifying an offset from the first subframe at which the pattern begins.

14. The access node of claim 12, wherein the step of signaling which of the SRS subframes are to be used for periodic SRS transmissions and which of the SRS subframes are to be used for aperiodic SRS transmissions further comprises:
transmitting a first message to a first UE that indicates a first set of subframes in which the first UE may transmit aperiodic SRS; and
transmitting a second message to a second UE that indicates a second set of subframes in which the second UE may transmit periodic SRS, wherein in a subframe the first UE transmits aperiodic SRS on a first SRS resource and the second UE transmits periodic SRS on a second SRS resource, and wherein the first SRS resource and the second SRS resource are different, and wherein an SRS resource comprises at least one of an SRS cyclic shift or an SRS comb or a set of resource blocks.

15. The access node of claim 12, wherein an access node transmits a cell-specific message that indicates which of the allocated subframes are one of periodic SRS subframes and aperiodic SRS subframes, and wherein the remainder of the allocated subframes are the other of periodic SRS subframes and aperiodic SRS subframes and wherein only an aperiodic SRS is transmitted in aperiodic SRS subframe when an SRS is transmitted in the aperiodic SRS subframe.

16. The access node of claim 15, wherein the access node further transmits a UE-specific message that contains UE-specific aperiodic SRS configuration information.

17. The access node of claim 16, wherein the cell-specific message and the UE-specific message are semi-static higher layer signaling.

18. The access node of claim 12, wherein the number of aperiodic SRS transmissions transmitted after a trigger is received is specified by one of a semi-static configuration and dynamic signaling.

19. The access node of claim 12, wherein multiple aperiodic SRS signals from different UEs are multiplexed in the frequency domain, and the frequency locations for each SRS signal vary in different subframes, and wherein the starting subcarrier index for an aperiodic SRS signal at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′}}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′}}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & \\ where {N}_{{b}_{hop}^{ASRS}} = 1. & \end{matrix}$$

20. The access node of claim 19, wherein n_{SRS} is calculated according to the equation
$${n}_{SRS} = {n}_{f} {N}_{ASRS} + {\sum }_{n = 0}^{⌊ {n}_{s} / 2 ⌋} g ( n )$$
where N_{ASRS} is the number of entries in T_{offset}^{ASRS}, i.e. the number of aperiodic SRS subframes in each frame, and
$$g ( n ) = \{ \begin{matrix}1 , & if n ∈ {T}_{offset}^{ASRS} \\ 0 , & otherwise\end{matrix}$$
where └x┘ indicates the maximum integer that is less than or equal to x.

21. The access node of claim 14, wherein multiple aperiodic SRS signals from different UEs are multiplexed in the frequency domain, and the frequency locations for each SRS signal vary in different subframes, and wherein the starting subcarrier index for an aperiodic SRS signal at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ 4 {n}_{RRC}^{ASRS} / {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′ }}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′ }}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & \end{matrix}$$
where N_{b}_{ₕₒₚ}_{^{ASRS}}=1, and wherein n_{SRS} is calculated according to the equation
n_{SRS}=└(n_{f}×10+└nₛ/2┘)/T_{ASRS}┘.

22. A user equipment (UE), comprising:
a processor configured such that the UE transmits a sounding reference signal (SRS), the UE having received a message that indicates a set of SRS subframes in which an SRS can be transmitted, wherein when the UE is a UE not capable of aperiodic SRS transmission the UE can be instructed to transmit periodic SRS in any of the SRS subframes, and the UE further having received a message that indicates which of the SRS subframes are to be used for periodic SRS transmissions and which of the SRS subframes are to be used for aperiodic SRS transmissions, wherein a periodic SRS transmission is an SRS transmission that is transmitted by a UE in a first subframe, the first subframe being determined at least by the subframe in which the UE transmitted a previous SRS and an SRS periodicity, and wherein an aperiodic SRS transmission is an SRS transmission that is transmitted by a UE in a second subframe, the second subframe being determined at least by a transmission on a physical control channel to the UE.

23. The UE of claim 22, wherein the set of SRS subframes in which the SRS can be transmitted is specified by a first entry in a table, each entry in the table containing a periodicity of allocated subframes and an offset from the first subframe at which the allocation period begins, and wherein the subframes to be used for periodic SRS transmissions and the subframes to be used for aperiodic SRS transmissions are specified by a second entry in the table, the periodicity portion of the second entry specifying a pattern of periodic and aperiodic subframes among the allocated subframes, and the offset portion of the second entry specifying an offset from the first subframe at which the pattern begins.

24. The UE of claim 22, wherein the step of signaling which of the SRS subframes are to be used for periodic SRS transmissions and which of the SRS subframes are to be used for aperiodic SRS transmissions further comprises:
transmitting a first message to a first UE that indicates a first set of subframes in which the first UE may transmit aperiodic SRS; and
transmitting a second message to a second UE that indicates a second set of subframes in which the second UE may transmit periodic SRS, wherein in a subframe the first UE transmits aperiodic SRS on a first SRS resource and the second UE transmits periodic SRS on a second SRS resource, and wherein the first SRS resource and the second SRS resource are different, and wherein an SRS resource comprises at least one of an SRS cyclic shift or an SRS comb or a set of resource blocks.

25. The UE of claim 22, wherein an access node transmits a cell-specific message that indicates which of the allocated subframes are one of periodic SRS subframes and aperiodic SRS subframes, and wherein the remainder of the allocated subframes are the other of periodic SRS subframes and aperiodic SRS subframes, and wherein only an aperiodic SRS is transmitted in aperiodic SRS subframe when an SRS is transmitted in the aperiodic SRS subframe.

26. The UE of claim 25, wherein the access node further transmits a UE-specific message that contains UE-specific aperiodic SRS configuration information.

27. The UE of claim 26, wherein the cell-specific message and the UE-specific message are semi-static higher layer signaling.

28. The UE of claim 22, wherein the number of aperiodic SRS transmissions transmitted after a trigger is received is specified by one of a semi-static configuration and dynamic signaling.

29. The UE of claim 22, wherein the starting subcarrier index at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ 4 {n}_{RRC}^{ASRS} / {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′}}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′}}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & \\ where {N}_{{b}_{hop}^{ASRS}} = 1. & \end{matrix}$$

30. The UE of claim 29, wherein n_{SRS} is calculated according to the equation
$${n}_{SRS} = {n}_{f} {N}_{ASRS} + {\sum }_{n = 0}^{⌊ {n}_{s} / 2 ⌋} g ( n )$$
where N_{ASRS} is the number of entries in T_{offset}^{ASRS}, i.e. the number of aperiodic SRS subframes in each frame, and
$$g ( n ) = \{ \begin{matrix}1 , & if n ∈ {T}_{offset}^{ASRS} \\ 0 , & otherwise\end{matrix}$$
where └x┘ indicates the maximum integer that is less than or equal to x.

31. The UE of claim 24, wherein multiple aperiodic SRS signals are multiplexed in the frequency domain, and the frequency locations for each SRS signal vary in different subframes, and wherein the starting subcarrier index at slot nₛ of system frame n_{f} is calculated according to the equation:
$$\begin{matrix}{k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b} π \\ where \\ {k}_{0}^{′} = ( ⌊ {N}_{RB}^{UL} / 2 ⌋ - {m}_{SRS , 0} / 2 ) {N}_{SC}^{RB} + {k}_{TC}^{ASRS} \\ {n}_{b} = \{ \begin{matrix}⌊ 4 {n}_{RRC}^{ASRS} / {m}_{SRS , b} ⌋ mod {N}_{b} & b \leq {b}_{hop}^{ASRS} \\ \{ {F}_{b} ( {n}_{SRS} ) + ⌊ 4 {n}_{RRC}^{ASRS} / {m}_{SRS , b} ⌋ \} mod {N}_{b} & otherwise\end{matrix} & \\ {F}_{b} ( {n}_{SRS} ) = \{ \begin{matrix}\begin{matrix}( {N}_{b} / 2 ) ⌊ \frac{{n}_{SRS} mod {\prod }_{{b}^{′} = {b}_{hop}^{ASRS}}^{b} {N}_{{b}^{′}}}{{\prod }_{{b}^{′} = {b}_{hop}^{ASRS}}^{b - 1} {N}_{{b}^{′}}} ⌋ + \\ ⌊ \frac{{n}_{SRS} mod {\prod }_{{b}^{′} = {b}_{hop}^{ASRS}}^{b} {N}_{{b}^{′}}}{2 {\prod }_{{b}^{′} = {b}_{hop}^{ASRS}}^{b - 1} {N}_{{b}^{′}}} ⌋\end{matrix} & if {N}_{b} even \\ ⌊ {N}_{b} / 2 ⌋ ⌊ {n}_{SRS} / {\prod }_{{b}^{′} = {b}_{hop}^{ASRS}}^{b - 1} {N}_{{b}^{′}} ⌋ & if {N}_{b} odd\end{matrix} & \end{matrix}$$
where N_{b}_{ₕₒₚ}^{ASRS}=1, and wherein n_{SRS} is calculated according to the equation
n_{SRS}=└(n_{f}×10+└nₛ/2┘)/T_{ASRS}┘.

32. A method for resource allocation, comprising:
dynamically signaling resources for a user equipment (UE) to use when transmitting an aperiodic sounding reference signal (SRS), wherein higher layer signaling indicates a set of resources that the UE can transmit on, and wherein dynamic physical layer signaling indicates which resources within the set of resources the UE is to use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

33. The method of claim 32, wherein the physical layer signaling specifies at least one of:
a starting subcarrier index for aperiodic SRS transmission;
an offset from the starting subcarrier index;
an aperiodic cyclic shift; and
an offset from the aperiodic cyclic shift.

34. The method of claim 33, wherein, when the physical layer signaling specifies the starting subcarrier index, the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 {n}_{RRC}^{ASRS} / {m}_{SRS , b} ⌋ mod {N}_{b} .$$

35. The method of claim 33, wherein, when the physical layer signaling specifies the offset from the starting subcarrier index, the offset from the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 ( {n}_{RRC}^{ASRS} + {n}_{Δ} ) / {m}_{SRS , b} ⌋ mod {N}_{b} .$$

36. The method of claim 33, wherein, when the physical layer signaling specifies the offset from the aperiodic cyclic shift, the aperiodic cyclic shift is calculated according to the equation:
Aperiodic SRS cyclicShift=(aperiodic-cyclicShift+aperiodic-cyclicShift-offset)Mod 8.

37. An access node in a wireless telecommunications system, comprising:
a processor configured such that the access node dynamically signals resources for a user equipment (UE) to use when transmitting an aperiodic sounding reference signal (SRS), wherein higher layer signaling indicates a set of resources that the UE can transmit on, and wherein dynamic physical layer signaling indicates which resources within the set of resources the UE is to use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

38. The access node of claim 37, wherein the physical layer signaling specifies at least one of:
a starting subcarrier index for aperiodic SRS transmission;
an offset from the starting subcarrier index;
an aperiodic cyclic shift; and
an offset from the aperiodic cyclic shift.

39. The access node of claim 38, wherein, when the physical layer signaling specifies the starting subcarrier index, the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 {n}_{RRC}^{ASRS} / {m}_{SRSR , b} ⌋ mod {N}_{b} .$$

40. The access node of claim 38, wherein, when the physical layer signaling specifies the offset from the starting subcarrier index, the offset from the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 ( {n}_{RRC}^{ASRS} + {n}_{Δ} ) / {m}_{SRS , b} ⌋ mod {N}_{b} .$$

41. The access node of claim 38, wherein, when the physical layer signaling specifies the offset from the aperiodic cyclic shift, the aperiodic cyclic shift is calculated according to the equation:
Aperiodic SRS cyclicShift=(aperiodic-cyclicShift+aperiodic-cyclicShift-offset)Mod 8.

42. A user equipment (UE), comprising:
a processor configured such that the UE transmits an aperiodic sounding reference signal (SRS) on resources that were dynamically signaled to the UE for use in transmitting the SRS, wherein the dynamic specification of the resources comprised higher layer signaling that indicated a set of resources that the UE can transmit on and dynamic physical layer signaling that indicated which resources within the set of resources the UE can use for transmitting the SRS, and wherein the dynamic physical layer signaling is carried on a physical control channel, and wherein an aperiodic SRS transmission is an SRS transmission that is transmitted by a UE in a subframe, the subframe being determined at least by a transmission on the physical control channel to the UE.

43. The UE of claim 42, wherein the physical layer signaling specifies at least one of:
a starting subcarrier index for aperiodic SRS transmission;
an offset from the starting subcarrier index;
an aperiodic cyclic shift; and
an offset from the aperiodic cyclic shift.

44. The UE of claim 43, wherein, when the physical layer signaling specifies the starting subcarrier index, the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 {n}_{RRC}^{ASRS} / {m}_{SRS , b} ⌋ mod {N}_{b} .$$

45. The UE of claim 43, wherein, when the physical layer signaling specifies the offset from the starting subcarrier index, the offset from the starting subcarrier index is calculated according to the equation:
$${k}_{0} ( {n}_{f} , {n}_{s} ) = {k}_{0}^{′} + {\sum }_{b = 0}^{{B}_{SRS}^{a}} {m}_{SRS , b} \cdot {N}_{SC}^{RB} \cdot {n}_{b}$$
$$where$$
$${k}_{0}^{′} = ( ⌊ {N}_{RB}^{UL} / 2 ⌋ - {m}_{SRS , 0} / 2 ) {N}_{SC}^{RB} + {k}_{TC}^{ASRS}$$
$${n}_{b} = ⌊ 4 ( {n}_{RRC}^{ASRS} + {n}_{Δ} ) / {m}_{SRS , b} ⌋ mod {N}_{b} .$$

46. The UE of claim 43, wherein, when the physical layer signaling specifies the offset from the aperiodic cyclic shift, the aperiodic cyclic shift is calculated according to the equation:
Aperiodic SRS cyclicShift=(aperiodic-cyclicShift+aperiodic-cyclicShift-offset)Mod 8.
